(19) United States
(12) Patent Application Publication
(10) Pub. No.: US 2017/0287632 A1
(43) Pub. Date: Oct. 5, 2017

(54) RADIALLY ANISOTROPIC SINTERED RING MAGNET AND ITS PRODUCTION METHOD

(71) Applicant: HITACHI METALS, LTD., Tokyo (JP)

(72) Inventor: Takahiro KATOU, Kumagaya-shi (JP)

(73) Assignee: HITACHI METALS, LTD., Tokyo (JP)

(21) Appl. No.: 15/508,333

(22) PCT Filed: Aug. 27, 2015
(86) PCT No.: PCT/JP2015/074214

§ 371 Date: Mar. 2, 2017

(30) Foreign Application Priority Data
Sep. 3, 2014 (JP) 2014-178967

(51) Int. Cl. H01F 41/02; C22C 38/00; H01F 7/02; B22F 3/16

(52) U.S. Cl. CPC H01F 41/028; B22F 3/16; C22C 38/005; C22C 38/002; H01F 7/021; H01F 41/0253; B22F 2202/05; B22F 2301/355

(57) ABSTRACT

A method for producing a radially anisotropic sintered ring magnet by continuously repeating a step of supplying magnetic powder to a die comprising a columnar magnetic core, and a cylindrical outer die having axially connected magnetic member and non-magnetic member, with a cavity between the core and the cylindrical outer die, and a step of compression-molding the magnetic powder in a radial magnetic field applied between the magnetic core and the magnetic member of the outer die, plural times in one die, to form a final green body composed of pluralities of integrally connected green bodies; and sintering the final green body; the magnetic field being applied in a state where an upper end of the magnetic member of the cylindrical outer die is higher than an upper surface of the magnetic powder supplied.

### FIELD OF THE INVENTION

The present invention relates to a radially anisotropic sintered ring magnet produced by multi-step molding, and its production method, particularly to a radially anisotropic sintered ring magnet having a uniform surface magnetic flux waveform in an axial direction with suppressed dents at connections of multi-step-molding, and its production method.

### BACKGROUND OF THE INVENTION

R-TM-B permanent magnets, wherein R is one or more rare earth elements including Y, and TM is at least one transition metal and includes Fe, are widely used because of inexpensiveness and high magnetic properties. Because R-TM-B magnets have excellent magnetic properties and high mechanical strength and are resistant to internal stress due to sintering shrinkage because of little brittleness, they are suitably used for radially anisotropic, multi-polar ring magnets, contributing to providing motors with higher power and smaller sizes.

To obtain a radially anisotropic sintered ring magnet, as shown in FIG. 1, magnetic powder is charged into a cavity 3 of a die comprising a columnar magnetic core 1 (inner side) and a cylindrical outer die 2 (outer side), and molded in a radial magnetic field. To efficiently orient magnetic powder charged into the cavity, the outer die 2 comprises a cavity-constituting magnetic member 2a (molding portion), and a non-magnetic member 2b arranged axially adjacent to the magnetic member 2a. When molding is conducted by such a die, a magnetic field necessary for radially orienting magnetic powder is determined by the amount of magnetic flux passing through the core. Accordingly, when a radially anisotropic sintered ring magnet has a small inner diameter or a large axial size, a magnetic flux density usable for the orientation of magnetic powder is too small to obtain sufficient orientation of magnetic powder.

As a method of sufficiently orienting magnetic powder in the molding of a radially anisotropic ring magnet having a large axial size, JP 2-281721 A discloses a method for forming a multi-step-molded green body composed of pluralities of connected green body parts by molding a starting material powder charged into a cavity in a magnetic field, charging new magnetic powder on the resultant green body part in the cavity, and molding the new magnetic powder in a magnetic field. However, the multi-step-molding method of JP 2-281721 A likely suffers cracking in connecting planes of green body parts.

JP 10-55929 A discloses a method for producing a radially anisotropic ring magnet by multi-step molding, wherein pluralities of preliminary green bodies are molded such that a final green body is formed by final pressing; the final green body having a higher density than those of the preliminary green bodies to make the radially anisotropic ring magnet free from cracking while keeping magnetic properties. However, it has been found that a sintered body produced by the multi-step-molding method of JP 10-55929 A has dents in a surface magnetic flux density at connections of multi-step-molded magnets, exhibiting a non-uniform surface magnetic flux density distribution. For example, when this magnet is used for a rotor, troubles such as uneven rotation, etc. likely occur, so that improvement is desired.

### OBJECT OF THE INVENTION

Accordingly, an object of the present invention is to provide a radially anisotropic sintered ring magnet produced by a multi-step-molding method with reduced dents in a surface magnetic flux density at connections, and its production method.

### SUMMARY OF THE INVENTION

As a result of intensive research in view of the above object, the inventor has found that in the multi-step-compression-molding of magnetic powder supplied to a die comprising columnar magnetic core, and a cylindrical outer die comprising axially connected magnetic member and non-magnetic member, with a cavity between the core and the cylindrical outer die, in a radial magnetic field applied between the magnetic core and the magnetic member of the outer die, the positioning of an upper end of the magnetic member of the cylindrical outer die higher than an upper surface of the magnetic powder reduces dents in a magnetic flux density at connections. The present invention has been completed based on such findings.

Thus, the method of the present invention for producing a radially anisotropic sintered ring magnet comprises

continuously repeating a step of supplying magnetic powder to a die comprising a columnar magnetic core, and a cylindrical outer die having axially connected magnetic member and non-magnetic member, with a cavity between the core and the cylindrical outer die, and a step of compression-molding the magnetic powder in a radial magnetic field applied between the magnetic core and the magnetic member of the outer die, plural times in one die, to form a final green body composed of pluralities of integrally connected green bodies; and

sintering the final green body;

the magnetic field being applied in a state where an upper end of the magnetic member of the cylindrical outer die is higher than an upper surface of the magnetic powder supplied.

After the step of supplying magnetic powder, the cylindrical outer die is preferably moved until an upper end of the magnetic member of the cylindrical outer die becomes higher than an upper surface of the magnetic powder supplied.

The compression-molding pressure of the final green body is preferably higher than that of a previous-step green body (preliminary green body).

The preliminary green body preferably has a density of 3.1 g/cm³ or more, and the density of the final green body is preferably 0.2 g/cm³ or more higher than that of the preliminary green body.

The radially anisotropic sintered ring magnet of the present invention has a connection in a plane perpendicular to the axial direction, with no decrease in a surface magnetic flux density at the connection.

The radially anisotropic sintered ring magnet of the present invention has a connection in a plane perpendicular to the axial direction, a surface magnetic flux density (mT) at the connection being larger than a value obtained by subtracting 25 (mT) from an average of magnetic flux densities (mT) at positions of +5 mm and −5 mm, respectively, axially separate from the connection.

The radially anisotropic sintered ring magnet of the present invention is preferably obtained by axially connecting pluralities of green bodies, and sintering the resultant multi-connection green body.

### EFFECTS OF THE INVENTION

The method of the present invention can produce a radially anisotropic sintered ring magnet having a large axial size with a high, uniform surface magnetic flux density, with substantially no dents in a magnetic flux density at connections of pluralities of multi-step-molded green bodies.

### BRIEF DESCRIPTION OF THE DRAWINGS

FIG. 1 is a schematic view showing an example of apparatuses for molding a radially anisotropic ring magnet in a magnetic field.

FIG. 2(a) is a schematic view for explaining a conventional method for multi-step-molding a radially anisotropic ring magnet in a magnetic field.

FIG. 2(b) is a schematic view for explaining a conventional method for multi-step-molding a radially anisotropic ring magnet in a magnetic field.

FIG. 2(c) is a schematic view for explaining a conventional method for multi-step-molding a radially anisotropic ring magnet in a magnetic field.

FIG. 2(d) is a schematic view for explaining a conventional method for multi-step-molding a radially anisotropic ring magnet in a magnetic field.

FIG. 2(e) is a schematic view for explaining a conventional method for multi-step-molding a radially anisotropic ring magnet in a magnetic field.

FIG. 2(f) is a schematic view for explaining a conventional method for multi-step-molding a radially anisotropic ring magnet in a magnetic field.

FIG. 2(g) is a schematic view for explaining a conventional method for multi-step-molding a radially anisotropic ring magnet in a magnetic field.

FIG. 2(h) is a schematic view for explaining a conventional method for multi-step-molding a radially anisotropic ring magnet in a magnetic field.

FIG. 2(i) is a schematic view for explaining a conventional method for multi-step-molding a radially anisotropic ring magnet in a magnetic field.

FIG. 2(j) is a schematic view for explaining a conventional method for multi-step-molding a radially anisotropic ring magnet in a magnetic field.

FIG. 2(k) is a schematic view for explaining a conventional method for multi-step-molding a radially anisotropic ring magnet in a magnetic field.

FIG. 2(l) is a schematic view for explaining a conventional method for multi-step-molding a radially anisotropic ring magnet in a magnetic field.

FIG. 2(m) is a schematic view for explaining a conventional method or multi-step-molding a radially anisotropic ring magnet in a magnetic field.

FIG. 2(n) is a schematic view for explaining the multi-step-molding method of the present invention for producing a radially anisotropic ring magnet in a magnetic field.

FIG. 2(o) is a schematic view for explaining the multi-step-molding method of the present invention for producing a radially anisotropic ring magnet in a magnetic field.

FIG. 2(p) is a schematic view for explaining the multi-step-molding method of the present invention for producing a radially anisotropic ring magnet in a magnetic field.

FIG. 2(q) is a schematic view for explaining the multi-step-molding method of the present invention for producing a radially anisotropic ring magnet in a magnetic field.

FIG. 3 is a graph showing the relation between the direction of a magnetic flux density vector (axial deviation from the radial direction) and an axial position, in a sintered magnet obtained by a conventional molding method in a radial magnetic field.

FIG. 4 is a schematic view showing a radial magnetic field in which a conventional molding method is conducted.

FIG. 5 is a schematic view showing a radial magnetic field in which the molding method of the present invention is conducted.

FIG. 6 is a schematic view showing the axial surface magnetic flux density distribution of a radially anisotropic sintered ring magnet obtained by a conventional multi-step molding method.

FIG. 7 is a schematic view showing the axial surface magnetic flux density distribution of a radially anisotropic sintered ring magnet obtained by the multi-step molding method of the present invention.

### DESCRIPTION OF THE PREFERRED EMBODIMENTS

[1] Radially Anisotropic Sintered Ring Magnet

The radially anisotropic sintered ring magnet is preferably substantially R-TM-B. R is at least one of rare earth elements including Y, preferably containing at least one of Nd, Dy and Pr as an indispensable element. TM is at least one transition metal, preferably Fe. It preferably has a composition comprising 24-34% by mass of R, and 0.6-1.8% by mass of B, the balance being Fe. Part of Fe may be substituted by Co. It may further contain elements such as Al, Si, Cu, Ga, Nb, Mo, W, etc. in an amount of about 3% or less by mass.

The radially anisotropic sintered ring magnets of the present invention are connected in planes perpendicular to the axial direction, substantially without dents in a surface magnetic flux density at the connected portions (connections). As described in JP 10-55929 A, conventional radially anisotropic sintered magnets with connections have dents in an axially measured surface magnetic flux density at the connections. When radially anisotropic sintered ring magnets having such a non-uniform surface magnetic flux density are used, for example, for rotors of motors, the motors may suffer a large cogging torque. On the other hand, the radially anisotropic sintered ring magnet of the present invention does not have such non-uniformity in an axially measured surface magnetic flux density, so that it can constitute a motor free from cogging torque.

The surface magnetic flux density (mT) at each connection is preferably larger than a value obtained by subtracting 25 (mT) from an average of surface magnetic flux densities (mT) at positions of +5 mm and −5 mm, respectively, axially separate from the connection. Namely, assuming that a surface magnetic flux density at the connection is B₁ (mT), that a surface magnetic flux density at a position of +5 mm axially separate from the connection is B₂ (mT), and that a surface magnetic flux density at a position of −5 mm axially separate from the connection is B₃ (mT), the relation of B₁>[(B₂+B₃)/2]−25 is preferably met, and the relation of B₁>[(B₂+B₃)/2]−15 is more preferably met.

The radially anisotropic sintered ring magnet of the present invention is preferably obtained by axially connecting pluralities of green bodies, and sintering the resultant multi-connection green body. It is particularly obtained by the later-described production method of the present invention.

[2] Production Method

(1) Preparation and Pulverization of Alloy

Starting materials are mixed to the above composition, and melted to prepare an alloy, which is then pulverized. The pulverization of the alloy comprises coarse pulverization and fine pulverization. Coarse pulverization is preferably conducted by a stamp mill, a jaw crusher, a Braun mill, a disc mill, etc. or by a hydrogen absorption method. Fine pulverization is preferably conducted by a jet mill, a vibration mill, a ball mill, etc. In any case, the pulverization is conducted preferably in a non-oxidizing atmosphere using an organic solvent or an inert gas, to prevent oxidation. Particle sizes by pulverization are preferably 2-5 μm (measured by F.S.S.S.).

(2) Molding

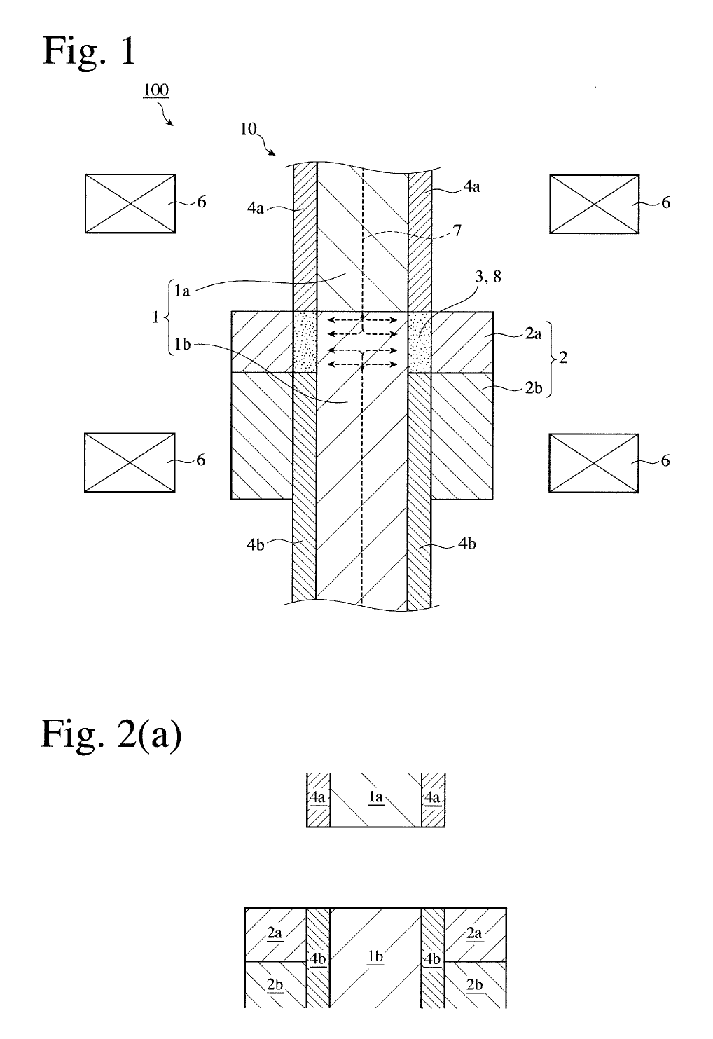

Molding for the radially anisotropic sintered ring magnet is conducted, for example, by a molding apparatus 100 comprising a die 10 and a magnetic-field-generating coil 6 as shown in FIG. 1. The die 10 comprises a columnar core 1 comprising an upper core 1a and a lower core 1b, a cylindrical outer die 2 constituting a cavity 3 with the lower core 1b, a lower columnar punch 4b constituting a bottom portion of the cavity 3, and an upper columnar punch 4a constituting an upper portion of the cavity 3 for compressing magnetic powder 8. The upper core 1a is separable from the lower core 1b, and the upper punch 4a is separable from the cavity 3. The upper core 1a and the upper punch 4a are separately movable up and down. The outer die 2, which comprises a magnetic member 2a defining the cavity 3, and a non-magnetic member 2b arranged axially adjacent to the magnetic member 2a, is movable up and down independently or with the lower core 1b. A pair of magnetic-field-generating coils 6 are arranged around the upper core 1a and the lower core 1b, such that a radial magnetic field 7 is applied to the cavity 3 through the contacted upper and lower cores 1a, 1b.

The method of the present invention for producing an anisotropic sintered magnet comprises continuously repeating compression molding in a magnetic field plural times in the same die to produce a final green body composed of pluralities of integrally connected green bodies, and sintering the final green body. The molding method of the present invention basically differs from conventional molding methods, only in how a magnetic field is applied in each compression-molding step, specifically in the position of the outer die when a magnetic field is applied. Accordingly, before explaining the molding method in the production method of the present invention, a conventional molding method will be explained for comparison.

(A) Conventional Method

A conventional molding method comprises the following steps. (a)

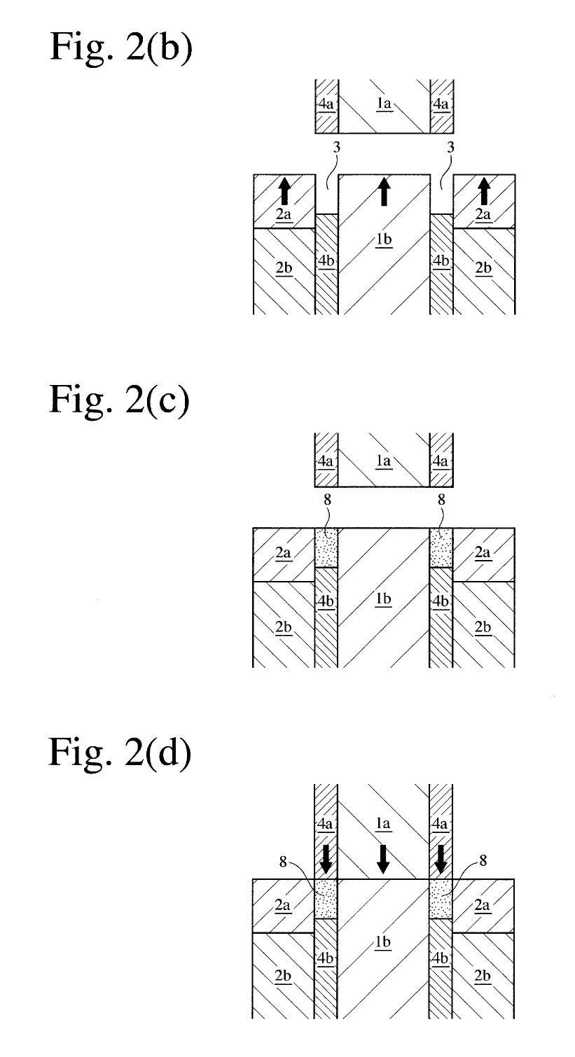

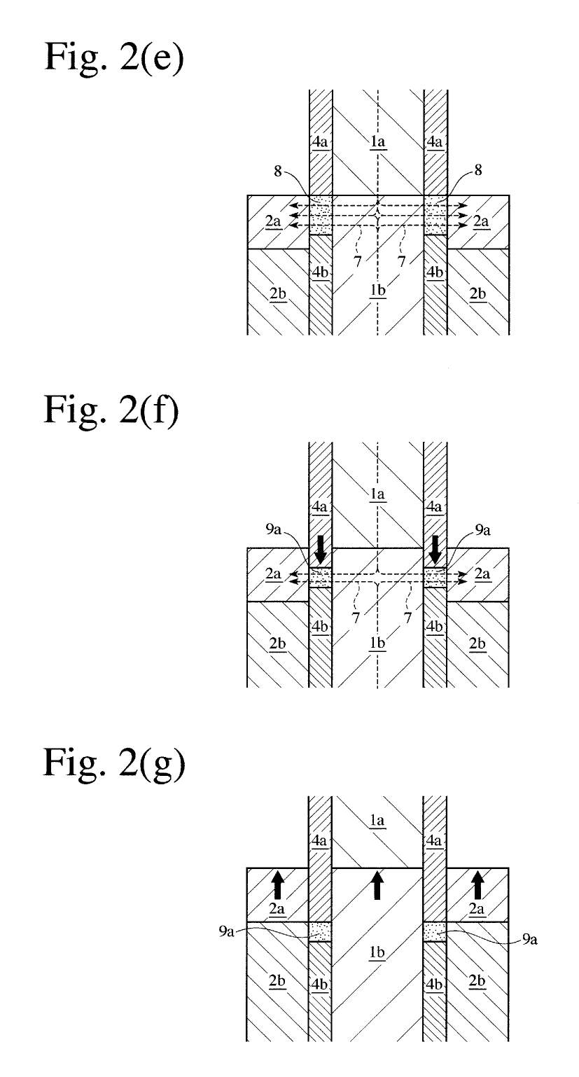

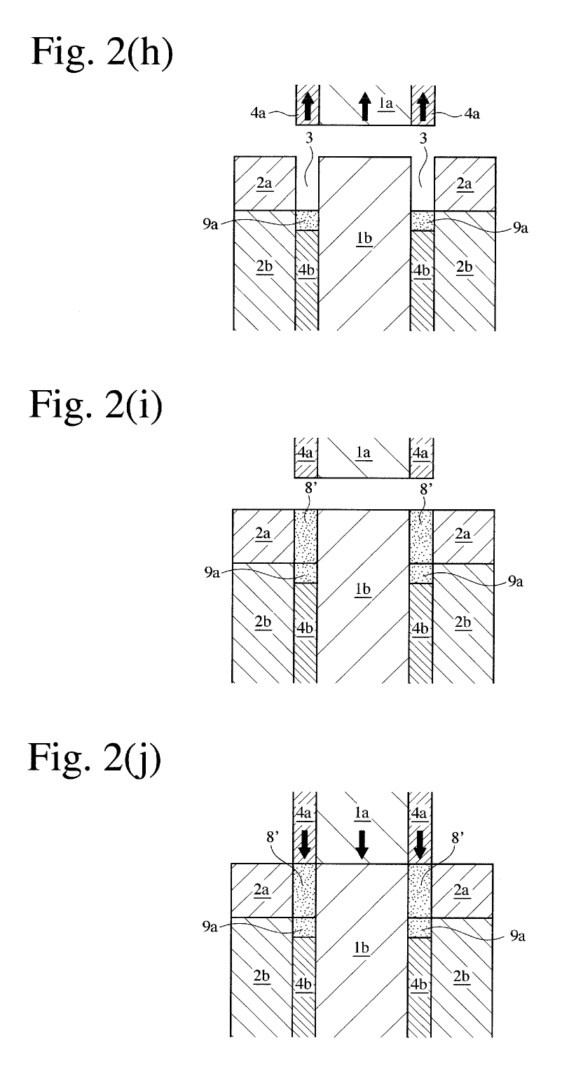

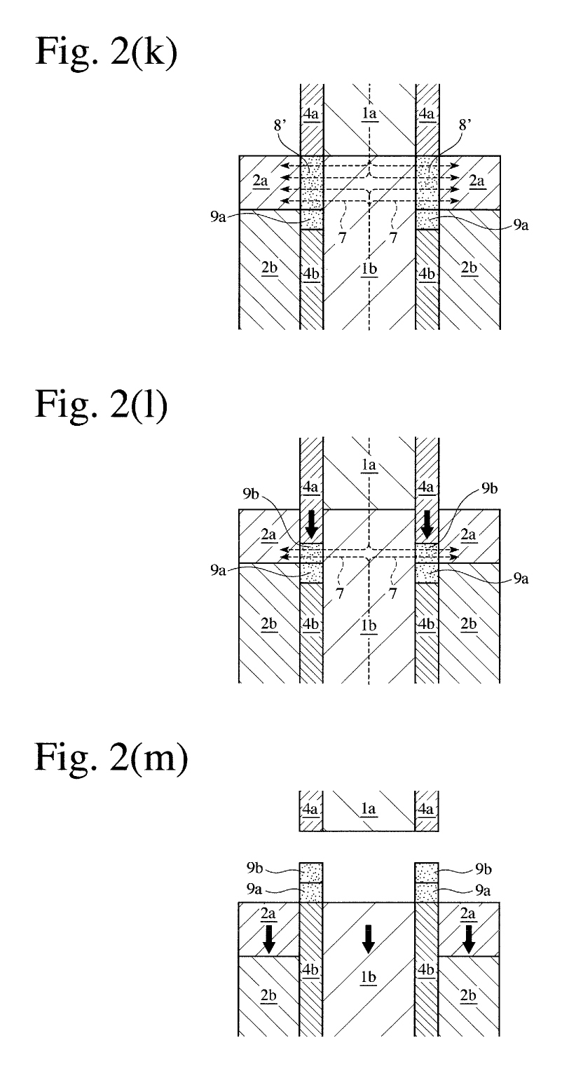

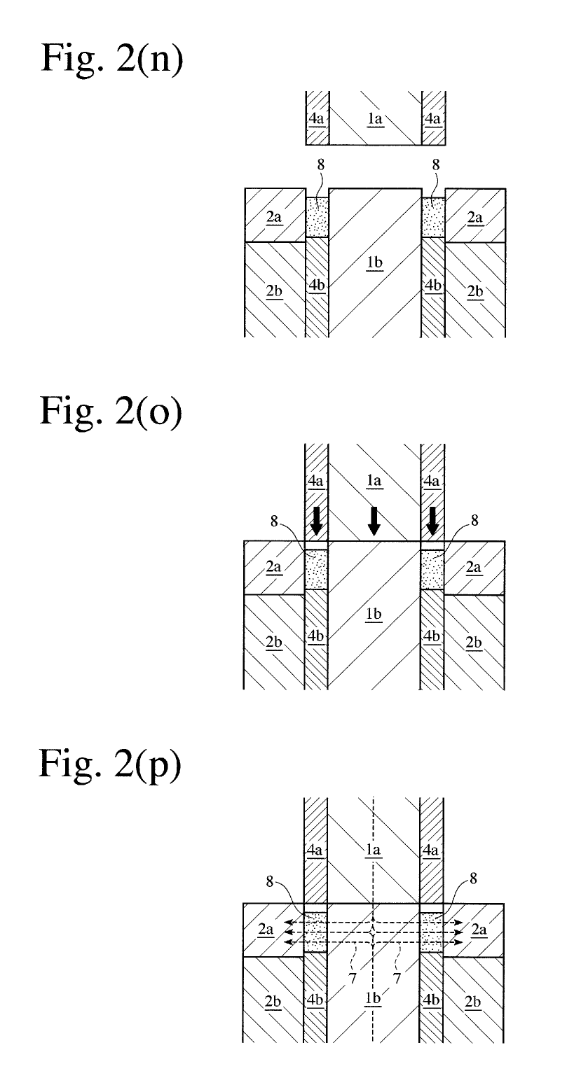

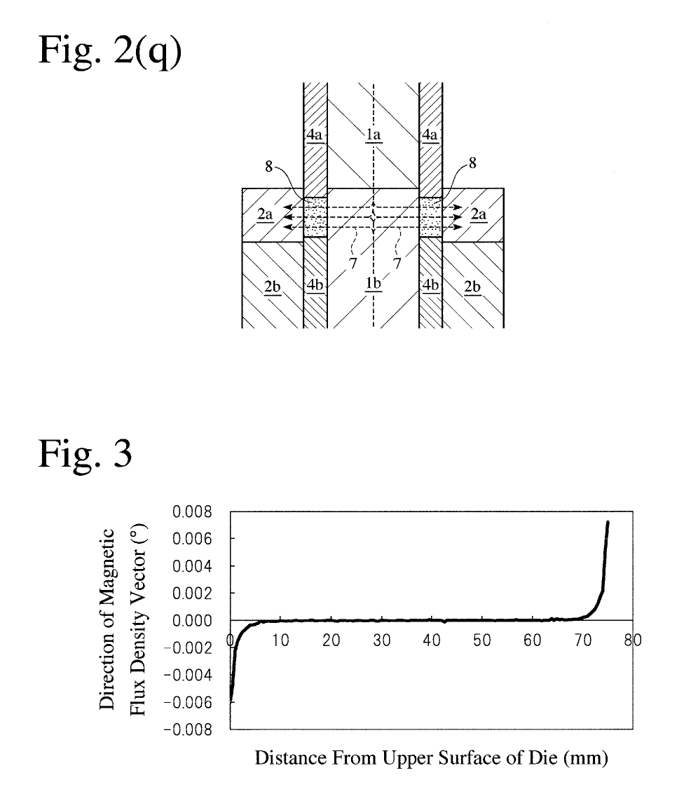

From a waiting state in which an upper core 1a and an upper punch 4a are upward separate from a lower core 1b and a lower punch 4b, respectively [FIG. 2(a)], (b) the lower core 1b and the outer die 2 are moved upward to form a cavity 3 between the lower core 1b and a magnetic member 2a of the outer die 2 [FIG. 2(b)], and (c) magnetic powder 8 is supplied to the cavity 3 [FIG. 2(c)]. With magnetic powder overflowing from the cavity 3 removed by a scraper, etc., the magnetic powder 8 supplied is flattened such that its upper surface has the same height as that of the upper end surfaces of the lower core 1b and the magnetic member 2a of the outer die 2. Though magnetic powder 8 is supplied in the step (c) after forming the cavity 3 by upward moving the lower core 1b and the outer die 2 in the step (b), the magnetic powder 8 may be supplied while upward moving the lower core 1b and the outer die 2 (while forming the cavity 3). (d) An upper core 1a and an upper punch 4a are then moved downward, until they come into contact with the upper end surfaces of the lower core 1b and the cavity 3 (magnetic powder 8), respectively [FIG. 2(d)]. (e) A radial magnetic field 7 is applied from a magnetic-field-generating coil 6 (see FIG. 1) to the magnetic powder 8 [FIG. 2(e)], and (f) the upper punch 4a is moved downward in a magnetic field 7, thereby compressing the magnetic powder 8 to form a first green body 9a [FIG. 2(f)]. (g) After molding, the magnetic-field-generating coil 6 stops generating a magnetic field 7 in a state where the upper punch 4a is in contact with the first green body 9a, and the lower core 1b and the outer die 2 are moved upward [FIG. 2(g)].

(h) The upper core 1a and the upper punch 4a are upward separated from the lower core 1b and the first green body 9a, to form a cavity 3 between the first green body 9a and the lower core 1b and the magnetic member 2a of the outer die 2 [FIG. 2(h)]. (i) New magnetic powder 8′ is supplied to the cavity 3 [FIG. 2(i)]. With magnetic powder overflowing from the cavity 3 removed by a scraper, etc. as in the step (c), the magnetic powder 8′ supplied is flattened such that its upper surface has the same height as that of the upper end surfaces of the lower core 1b and the magnetic member 2a of the outer die 2. (j) The upper core 1a and the upper punch 4a are then moved downward until they come into contact with the upper end surfaces of the lower core 1b and the cavity 3 (magnetic powder 8′) [FIG. 2(j)]. (k) A radial magnetic field 7 is applied from the magnetic-field-generating coil 6 to the magnetic powder 8′ [FIG. 2(k)], and (l) the upper punch 4a is moved downward in a magnetic field 7, thereby compressing the magnetic powder 8′ to form a second green body 9b integrally on the first green body 9a [FIG. 2(l)]. (m) The lower core 1b and the outer die 2 are moved downward to form a final green body, in which the first green body 9b and the second green body 9b are integrally combined [FIG. 2(m)].

Though the multi-step molding method in this example repeats molding two times to form a final green body in which two green bodies are connected, a final green body in which three or more green bodies are connected can be formed by repeating the steps (g) to (l) after the step (l).

Presuming that a cause of dents at connections in a surface magnetic flux density measured in an axial direction on a sintered magnet obtained from a green body formed by the conventional multi-step molding method is the disturbance of the orientation of magnetic powder near connections of adjacent green bodies, the inventor has measured vectors (axial deviations from the radial direction) of a surface magnetic flux density on a sintered magnet obtained from the first green body in the axial direction of the die, finding that the orientation of magnetic powder is disturbed near an upper end of the first green body 9a as shown in FIG. 3.

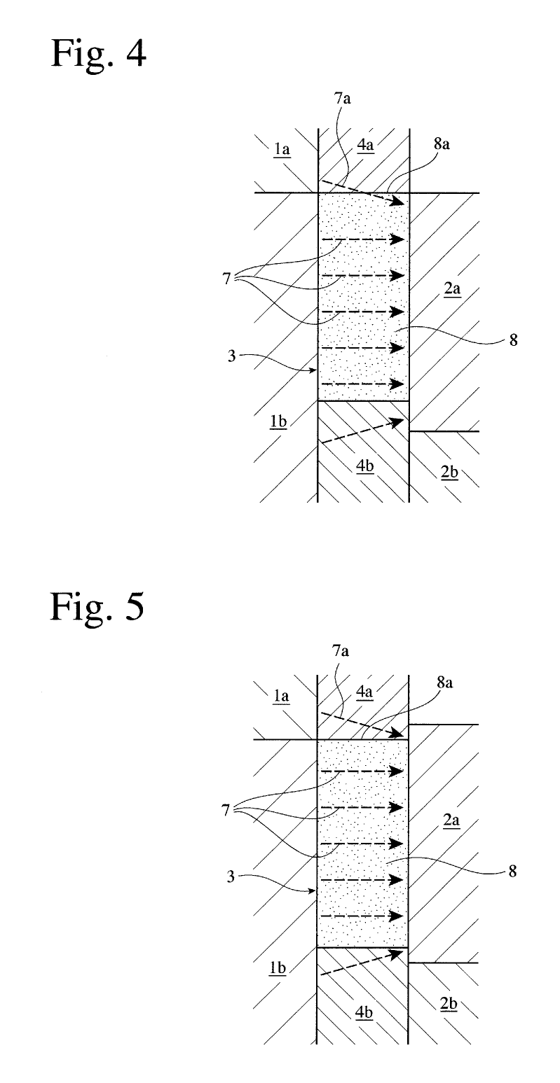

The inventor has further presumed that this disturbance of the orientation of magnetic powder is caused by a magnetic field applied when an upper surface of the magnetic powder 8 charged is as high as the upper end surface of the magnetic member 2a of the outer die 2 [see FIG. 2(e)]. Namely, the inventor has presumed that as shown in FIG. 4, a magnetic field 7a passing near the upper surface 8a of the magnetic powder 8 is slightly deviating axially from the radial direction, resulting in the disturbance of the orientation of magnetic powder near an upper end of a green body corresponding to the upper surface 8a of the magnetic powder 8, so that a sintered magnet obtained by the multi-step molding method has a surface magnetic flux density having dents at connections. Investigating the arrangement of an outer die for forming a radial magnetic field near the upper surface 8a of the magnetic powder 8, the method of the present invention as described below has been achieved.

(B) Method of the Present Invention

A molding method in the method of the present invention is the same as the above-described conventional method, except that a step (n) of moving the outer die 2 upward, such that the upper end surface of the magnetic member 2a of the outer die 2 becomes higher than an upper surface of the magnetic powder 8 supplied, as shown in FIG. 2(n), is added after the step (c) of supplying magnetic powder 8 to the cavity 3, and that the steps (d) and (e) are changed to a step (o) shown in FIG. 2(o) and a step (p) shown in FIG. 2(p), respectively.

Accordingly, (n) after the outer die 2 is moved upward to a point where the upper end surface of the magnetic member 2a of the outer die 2 is higher than the upper surface of the magnetic powder 8 supplied; (o) the upper core 1a and the upper punch 4a are moved downward, to a point where the upper core 1a comes into contact with the upper end surface of the lower core 1b, while the upper punch 4a does not have contact with the upper end surface of the magnetic powder 8 [FIG. 2(o)]; and (p) a radial magnetic field 7 is applied to the magnetic powder 8 in such a state [FIG. 2(p)], followed by the step (f) of compressing the magnetic powder 8 as in the conventional method.

Thus, with a magnetic field applied in a state where the upper end surface of the magnetic member 2a of the outer die 2 is higher than the upper surface 8a of the magnetic powder 8 supplied, a magnetic field 7a slightly deviating from the radial direction does not pass through the magnetic powder 8 as shown in FIG. 5, so that the disturbance of orientation does not occur near the upper surface 8a of the magnetic powder 8. As a result, a sintered magnet having substantially no dents in a surface magnetic flux density at connections is produced by the multi-step molding method. The upper end surface of the magnetic member 2a of the outer die 2 is desirably 5 mm or more, more desirably 10 mm or more, higher than the upper surface of the magnetic powder 8.

Though a magnetic field is applied in the step (p) in a state where the lower end surface of the upper punch 4a has the same height as that of the upper end surface of the magnetic member 2a of the outer die 2, leaving a gap between the lower end surface of the upper punch 4a and the upper surface of the magnetic powder 8, as shown in FIG. 2(p), a magnetic field may be applied in a state where the upper punch 4a inserted into the cavity 3 is in contact with the upper surface of the magnetic powder 8, as shown in FIG. 2(q). In this case, the upper punch 4a is brought into slight contact with the magnetic powder 8 without compression, so that the disturbance of the magnetic powder 8 can be suppressed while applying a magnetic field, and that the surface magnetic flux density is prevented from decreasing at connections. The upper punch 4a inserted into the cavity 3 need not be in contact with the magnetic powder 8 (there may be a gap). The depth of the upper punch 4a inserted into the cavity is desirably 0-10 mm, though variable depending on the positional relation between the upper surface of the magnetic powder 8 and the upper end surface of the magnetic member 2a of the outer die 2.

Though the lower core 1b and the outer die 2 are elevated to form a cavity 3 after the upper surface of the magnetic powder 8 supplied is flattened as high as the upper end surfaces of the lower core 1b and the magnetic member of the outer die 2, as described above, a magnetic field may be applied while controlling the supply of the magnetic powder 8 such that its upper surface is lower than the upper end surface of the outer die 2.

Two green bodies formed by repeating molding two times are connected to a final green body in the above-described example, but when three or more green bodies are connected to a final green body, the step (n) should be added after the step (i) of supplying magnetic powder 8′, and the steps (j) and (k) should be changed to have a space above the cavity 3 as in the steps (o) and (p). Because end portions of the sintered magnet are generally cut off, the step (i) may be followed by the steps (j) and (k) with the step (n) omitted, when magnetic powder supplied in the step (i) is formed into a final green body in the multi-step molding. For example, when a final green body composed of five connected green bodies is produced, the step (n) is added after the first step of supplying magnetic powder [after the step (c)] and the second to fourth steps of supplying magnetic powder [after the first, second and third steps (i)], but the step (n) need not be added after the fifth step of supplying magnetic powder.

In the present invention, a green body obtained by final compression molding among plural times of compression molding is called “final green body,” and a green body obtained by previous compression molding is called “preliminary green body.” For example, when a final green body composed of five connected green bodies is produced, green bodies obtained by the first to fourth compression molding are called “preliminary green bodies,” and a green body obtained by the fifth (final) compression molding is called “final green body.”

The preliminary green body preferably has a density of 3.1 g/cm³ or more. The method of the present invention has a step (g) of moving the core and the outer die with a preliminary green body pushed to wall surfaces of the core and the outer die. Thus, when the preliminary green body has a density of less than 3.1 g/cm³, namely when a preliminary green body has too much voids, powder in the green body may move by friction with the wall surfaces of the core and the outer die, resulting in the rotation of magnetic-field-oriented magnetic powder to different directions from the magnetic field direction. As a result, the orientation of a preliminary green body is likely disturbed, failing to obtain sufficient magnetic properties. When the preliminary green body has a density of 3.1 g/cm³ or more, magnetic powder in the preliminary green body near the wall surfaces does not move by the movement of the core and the outer die, avoiding decrease in magnetic properties.

With small density difference between a preliminary green body and a final green body, a sintered body may have cracks at connections. Accordingly, the density difference between the preliminary green body and the final green body is preferably 0.2 g/cm³ or more. With the density difference of 0.2 g/cm³ or more, sintering cracking can be prevented effectively.

The molding pressure of a final green body is preferably 0.5-2 ton/cm². Molding pressure of less than 0.5 ton/cm² provides the final green body with too small strength, while molding pressure of more than 2 ton/cm² disturbs the orientation of magnetic powder, resulting in low magnetic properties. Taking into consideration the density difference between the preliminary green body and the final green body, the compression-molding pressure of the final green body is preferably higher than that of the preliminary green body.

The intensity of a radial magnetic field applied to the cavity 3 to orient magnetic powder is preferably 159 kA/m or more, more preferably 239 kA/m or more. When the intensity of an orienting magnetic field is less than 159 kA/m, the magnetic powder is not fully oriented, failing to obtain good magnetic properties.

In the magnetic-field-applying step in the conventional technology and the present invention, the upper core 1a and the upper punch 4a are moved downward, such that the upper core 1a comes into contact with the lower core 1b, and the lower end surface of the upper punch 4a comes into contact with the upper end surface of the cavity 3, for purposes described below. The contact of the upper core 1a with the lower core 1b is to effectively utilize a magnetic field generated from a coil without forming a magnetic gap between the upper core 1a and the lower core 1b. The contact of the lower end surface of the upper punch 4a with the upper end surface of the cavity 3 is to prevent magnetic powder 8 from scattering from the cavity 3 while a magnetic field is applied. When a sufficient magnetic field is obtained in the cavity without contact of the upper core 1a and the lower core 1b, the upper and lower cores 1a, 1b need not be contacted. When magnetic powder 8 does not scatter even if the lower end surface of the upper punch 4a is above the upper end surface of the cavity 3, the lower end surface of the upper punch 4a need not be positioned at the upper end surface of the cavity 3. Though the cavity 3 per se is a space, an upper end surface of a space defined by the outer die 2 and the core 1 is conveniently called “upper end surface of the cavity 3.”

(3) Sintering

Sintering is conducted preferably at 1000-1150° C. in vacuum or in an argon atmosphere. The sintering is conducted preferably with a cylindrical body inserted into the ring to constrain the green body during sintering. With a green body sintered in a constrained state, the resultant radially anisotropic sintered ring magnet has improved roundness.

After sintering, the sintered body is preferably heat-treated. The heat treatment may be conducted before or after machining described below.

(4) Other Steps

The outer, inner and end surfaces of the resultant sintered body are preferably machined to necessary sizes, if necessary. A known apparatus such as an external grinding machine, an internal grinding machine, a planar grinding machine, etc. can be properly used for machining. To improve corrosion resistance, surface treatments such as plating, painting, aluminum vacuum vapor deposition, a chemical conversion treatment, etc. may be conducted, if necessary.

### EXAMPLE

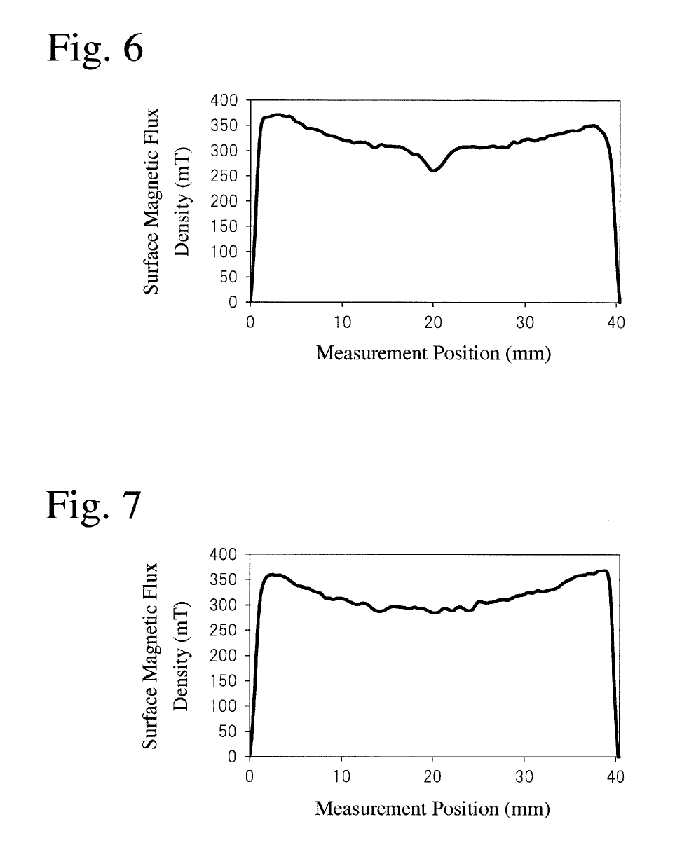

Using the molding apparatus shown in FIG. 1, R-TM-B alloy powder comprising 23.6% by mass of Nd, 2.2% by mass of Dy, 6.6% by mass of Pr, and 1% by mass of B, the balance being Fe and inevitable impurities was compression-molded in a magnetic field of 318 kA/m, to form integral two-connection green bodies, and sintered with a columnar body inserted into each green body, according to a conventional method and the method of the present invention. The sintered bodies were heat-treated to obtain radially anisotropic sintered ring magnets, whose surface magnetic flux densities were measured in an axial direction. The results are shown in FIG. 6 (conventional example) and FIG. 7 (the present invention).

As is clear from FIGS. 6 and 7, the radially anisotropic sintered ring magnet obtained from the multi-connection green body produced by the method of the present invention had no dents in a surface magnetic flux density at a connection (measured at 20 mm from an end surface), exhibiting an axially uniform surface magnetic flux density.

1. A method for producing a radially anisotropic sintered ring magnet comprising
continuously repeating a step of supplying magnetic powder to a die comprising a columnar magnetic core, and a cylindrical outer die having axially connected magnetic member and non-magnetic member, with a cavity between said core and said cylindrical outer die, and a step of compression-molding said magnetic powder in a radial magnetic field applied between said magnetic core and said magnetic member of said outer die, plural times in one die, to form a final green body composed of pluralities of integrally connected green bodies; and
sintering said final green body;
said magnetic field being applied in a state where an upper end of the magnetic member of said cylindrical outer die is higher than an upper surface of said magnetic powder supplied.

2. The method for producing a radially anisotropic sintered ring magnet according to claim 1, wherein after the step of supplying said magnetic powder, said cylindrical outer die is moved until an upper end of said magnetic member of said cylindrical outer die becomes higher than an upper surface of said magnetic powder supplied.

3. The method for producing a radially anisotropic sintered ring magnet according to claim 1, wherein the compression-molding pressure of said final green body is higher than that of a previous-step green body (preliminary green body).

4. The method for producing a radially anisotropic sintered ring magnet according to claim 3, wherein said preliminary green body has a density of 3.1 g/cm³ or more, and wherein the density of said final green body is 0.2 g/cm³ or more higher than that of said preliminary green body.

5. A radially anisotropic sintered ring magnet having a connection in a plane perpendicular to the axial direction, with no decrease in a surface magnetic flux density at said connection.

6. A radially anisotropic sintered ring magnet having a connection in a plane perpendicular to the axial direction, a surface magnetic flux density (mT) at said connection being larger than a value obtained by subtracting 25 (mT) from an average of magnetic flux densities (mT) at positions of +5 mm and −5 mm, respectively, axially separate from the connection.

7. The radially anisotropic sintered ring magnet according to claim 5, which is obtained by axially connecting pluralities of green bodies, and sintering the resultant multi-connection green body.
